(19) United States
(12) Patent Application Publication
(10) Pub. No.: US 2020/0279199 A1
(43) Pub. Date: Sep. 3, 2020

(54) GENERATING A COMPLETION PREDICTION OF A TASK

(71) Applicant: Hewlett Packard Enterprise Development LP, Houston, TX (US)

(72) Inventors: Subhajit Dasgupta, Austin, TX (US); Alexander Kramer, Frisco, TX (US); Robert R. Teisberg, Georgetown, TX (US)

(21) Appl. No.: 16/288,548

(22) Filed: Feb. 28, 2019

(51) Int. Cl. G06Q 10/06; G06N 7/00; G06N 20/00

(52) U.S. Cl. CPC G06Q 10/0631; G06N 20/00; G06N 7/005

(57) ABSTRACT

Example implementations relate to generating a completion prediction of a task. A computing device may comprise a processing resource and a memory resource storing non-transitory machine-readable instructions to cause the processing resource to receive task data about a task, analyze the task data using machine learning to generate a data model for the task, and generate a completion prediction based on the generated data model for the task.

### BACKGROUND

Tasks may be monitored for progression. For instance, a task may be monitored so that a user can be certain the task is progressing. In some instances, progression of a task can be indicated by a progression bar. A progression bar can allow a user to visually determine the progression of a task, including how far the task has progressed at a particular point in time. Progression of a task can give an indication to a user about an amount of time remaining until completion of the task, and/or if a potential issue may have arisen during execution of the task.

### BRIEF DESCRIPTION OF THE DRAWINGS

FIG. 1 illustrates an example system consistent with the disclosure.

FIG. 2 is a block diagram of an example computing device for generating a completion prediction of a task consistent with the disclosure.

FIG. 3 is a block diagram of an example system consistent with the disclosure.

FIG. 4 illustrates an example method consistent with the disclosure.

### DETAILED DESCRIPTION

Many tasks can be monitored for progression so that a user may determine a task is progressing. As used herein, the term “task” can, for example, refer to an assignment of work expected of an entity. For example, in a computing space, a task can include an assignment to a processor to execute instructions stored in memory to perform steps (e.g., a computing task). For instance, a computing device can receive a task with instructions to execute software. As used herein, the term “software” can, for example, refer to a set of instructions that are executed by a processor to perform a function. For example, the software can be a set of non-transitory machine-readable instructions that are executed by a processor to perform a coordinated function, task, and/or activity. As an example, a computing device can execute instructions to create a virtual machine (VM), where progression of the steps to create the VM may be monitored.

Monitoring progression of tasks, such as computing tasks, can be performed through a combination of analyzing elapsed time for tasks, as well as providing code hooks to indicate completion of significant steps of a task. Utilizing code hooks and elapsed time, progress can be indicated.

However, utilizing elapsed time and code hooks may not provide accurate completion indication. Improvements in underlying algorithms and/or improvements in underlying systems may render the task progression analysis obsolete. For example, progress indication for creation of a VM may have been accurate in the past, but software and/or computing hardware may have been upgraded and the elapsed time and code hooks analysis may not have been updated in order to account for the upgrades.

Additionally, development of task progression analyses may be performed in a controlled environment. Task progression analyses may be developed in a setting that may be different from real-world customer infrastructure. For example, task progression analyses may be freshly installed and not running under heavy load scenarios for significant periods of time. Progression measurements taken on a newly installed computing device system without heavy computing/memory utilization loads may differ from operational customer environments. As a result, development of task progression analyses may not be appropriate for all usage scenarios. Accordingly, controlled environment development of task progression analyses may provide inaccurate results when deployed by a customer.

Generating a completion prediction of a task, according to the disclosure, can allow for accurate generation of completion prediction for various types of tasks. Data about a task can be utilized in real time to generate accurate completion predictions for tasks using data models that are continually updated. As a result, improvements in underlying algorithms and/or improvements in underlying systems performing tasks can be dynamically accounted for, and task progression analyses can automatically tailor themselves for particular operational customer environments, ensuring accurate completion prediction for tasks.

FIG. 1 illustrates an example system 100 consistent with the disclosure. As illustrated in FIG. 1, the system 100 can include computing device 102 and task 104.

System 100 can include computing device 102. As used herein, the term “computing device” can, for example, refer to a device including a processor, memory, and input/output interfaces for wired and/or wireless communication. A computing device may include a laptop computer, a desktop computer, a mobile device, and/or other wireless devices, although examples of the disclosure are not limited to such devices. A mobile device may refer to devices that are (or may be) carried and/or worn by a user. For instance, a mobile device can be a phone (e.,. a smart phone), a tablet, a personal digital assistant (FDA), smart glasses, and/or a wrist-worn device (e.g., a smart watch), among other types of mobile devices.

Computing device 102 can be utilized for generating a completion prediction of a task 104. For example, computing device 102 can be utilized to generate a completion prediction of a task 104 using a particular data model. The completion prediction can be a time to completion, a percentage complete indication, or other completion prediction, as is further described herein.

Computing device 102 can receive task data about a task 104, As used herein, the term “task data” can, for example, refer to information about an assignment of work. For example, task 104 data can include a task start time of the task 104. For instance, the task 104 may be creation of a VM. The task start time of the task 104 can be, for instance, 8:00 AM. Task data can further include a task end time of the task 104. The task end time for creating the VM may be, for instance, 8:15 AM.

Although task data is described above as being a task start time and/or a task end time, examples of the disclosure are not so limited. For example, task data can include a task name, data about an underlying algorithm for the task 104, data about an underlying system performing the task 104, and/or any other data about a task 104.

Further, although the task 104 is described above as being a computing task (e.g., creation of a VM), examples of the disclosure are not so limited. For example, the task 104 can be a physical task. For example, the task 104 may be energy consumption of a physical room in a building during a time period, traffic patterns at intersections, cyclic network congestion on round-trip times in a network, Internet of Things (IoT) applications, among other types of tasks. In addition to a task 104 being a computing task, examples of the disclosure are not so limited. For example, the task 104 can be a sub-routine of a greater task (e.g., a sub-task that is performed as part of a larger task such as creating a VM). In other words, the task 104 can be part of any arbitrary system that is in some way based on timing measurements.

Computing device 102 can determine whether the task 104 has been performed before. Computing device 102 can determine whether the task 104 has been performed before based on a task name included in the received task data. For example, a task name may be “Create: LEI: logical-enclosures: NULL:” as part of creation of a VM. Computing device 102 can compare the task name to task names of previously completed tasks to determine whether the task 104 has been performed before.

In some examples, computing device 102 can determine that the task 104 has not been performed before. In response, computing device 102 can record a task start time and a task end time for the task 104. Utilizing the task start time and the task end time for the task 104, computing device 102 can determine a task completion time, as is further described herein. If computing device 102 determines that the task 104 has been performed before, computing device 102 can generate/update data models about the task 104, as is further described herein.

As described above, computing device 102 can receive task data about task 104. In some examples, computing device 102 can receive task data from an external system performing the task 104. In some examples, computing device 102 can periodically call to an external system for task data about task 104. For example, computing device 102 can periodically call to the external system at a predetermined interval for task data about task 104. In response to the periodic call, computing device 102 can receive the task data about task 104. In some examples, computing device 102 can call to the external system for historical task data about task 104. As used herein, the term “historical task data” can, for example, refer to task data about a task 104 that has been previously performed, and may include historical task start times, historical task end times, historical task names, among other historical task data about a task 104.

Computing device 102 can generate data models using task data about task 104. Computing device 102 can utilize machine learning to generate the data models. For example, computing device 102 can generate a Gaussian data model and a clustering data model utilizing the task data about task 104, as is further described herein.

Computing device 102 can generate a Gaussian data model for task 104 using the task data about task 104. As used herein, the term “Gaussian data model” can, for example, refer to a data model having a continuous probability distribution of data values. Generating the Gaussian data model is further described herein.

As described above, computing device 102 can determine whether the task 104 has been performed before. In response to the task 104 having been performed before, computing device 102 can make an initial prediction of task completion of task 104 using historical task data.

Upon completion of the task 104, computing device 102 can update the Gaussian data model. For example, computing device 102 can compare the initial prediction completion based on historical task data about task 104 with the actual task completion time of task 104. Computing device 102 can utilize a prediction formula (e.g., Equations 1 and 2, below) to determine and minimize a prediction error. For example:

a=(d−b*s)/m (Equation 1)

b=(d−a*m)/s (Equation 2)

where a is a floating point number representing a coefficient of the mean, b is a floating point number representing a coefficient of the standard deviation, d is a difference between the observed value and the predicted value of the task 104 (e.g., a difference between the initial prediction completion and the observed completion), m is a running mean, and s is a standard deviation. In some examples, the floating point number “a” can be initialized to 1.0 and the floating point number “b” can be initialized to 0.3. For example, computing device 102 can determine an initial prediction completion based on historical task data about a task, determine the time the task 104 actually took to complete, determine the prediction error, and minimize the prediction error. As computing device 102 continually updates the Gaussian data model for task 104 (e.g., as task 104 is completed and task data is continually updated and provided to computing device 102), the floating point integers “a” and “b” can begin to converge, allowing computing device 102 to accurately predict completion times for task 104.

Computing device 102 can generate a clustering data model for task 104 using the task data about task 104. As used herein, the term “clustering data model” can, for example, refer to a data model having data that is more similar to each other (e.g., a cluster) than data in other groups (e.g., other clusters). Generating the clustering data model is further described herein.

In some examples, computing device 102 can generate the clustering data model for task 104 using sequential K-Means analysis. As used herein, the term “K-Means analysis” can, for example, refer to a method of vector quantization in which n observations can be partitioned into k clusters in which each observation belongs to the cluster with the nearest mean value. The K-Means clustering analysis can include cluster sizes from 2 to 8. Computing device 102 can partition observations (e.g., task completion times for tasks) into the variously sized clusters.

For example, computing device 102 can determine a cluster size for task 104. For example, computing device 102 can determine a task completion time for task 104 and determine the cluster size for task 104 to be 2. Computing device 102 can, accordingly, classify task 104 into the cluster size of 2 for task 104.

As described above, computing device 102 can generate data models including a Gaussian data model and a clustering data model for task 104. Generating the Gaussian and clustering data models can allow computing device 102 to determine whether specific tasks exhibit Gaussian data distributions and/or clustered data distributions. This information can allow computing device 102 to make predictions about future instances of that task. As the Gaussian and clustering data models are continuously updated as new task data is received, training machine-learning models does not have to be performed. Further, since the Gaussian and clustering data models are continuously updated, changes in an underlying algorithm/underlying hardware architecture can be accounted for, allowing for accurate completion prediction times in an event a change is made.

Although a Gaussian data model and a clustering data model are described above as being generated by computing device 102 to generate a completion prediction, examples of the disclosure are not so limited. For example, computing device 102 can use any other data model, which can include a user specified/user supplied data model, among other examples of data models.

As described above, computing device 102 can generate a completion prediction for the task 104. Computing device 102 can generate the completion prediction for the task 104 using either the Gaussian data model for the task 104 or the clustering data model for the task 104. Whether the Gaussian data model or the clustering data model is used to generate the completion prediction for the task 104 is based on a prediction error of both data models, as is further described herein.

In some examples, the completion prediction for the task 104 can be generated in response to a user input. For example, a user of computing device 102 may be interested in monitoring completion of task 104. The user may request a completion prediction for task 104 from computing device 102 and, in response to the request, computing device 102 can generate a completion prediction.

The completion prediction can include a time to completion of task 104, a percentage completion indication of task 104, an amount of time for task 104 to complete, among other completion predictions. For example, task 104 may be creating a VM. Computing device 102 can determine a time left for task 104 to complete (e.g., 5 minutes), a percentage completion indication of creating the VM (e.g., 60% completed), a total amount of time for the creation of the VM to occur (e.g., 12 minutes), among other completion predictions.

Computing device 102 can generate the completion prediction using the Gaussian data model or the clustering data model based on a prediction error of the Gaussian data model and a prediction error of the clustering data model. For example, computing device 102 can determine the prediction errors of the Gaussian data model and the clustering data model, and generate the completion prediction using the particular data model having the lower prediction error, as is further described herein.

Computing device 102 can determine the prediction error of the Gaussian data model by generating an initial completion prediction for task 104 using the Gaussian data model. The initial completion prediction can be based on historical task data about task 104. For example, task 104 may have been performed 100 times in the past, and based on the historical task data about the past 100 performances of task 104, computing device 102 can generate the initial completion prediction for the current instance (e.g., the 101^{st} performance) of task 104.

Computing device 102 can compare the initial completion prediction using the Gaussian data model to an actual task completion time of the task. For example, task 104 can be creating a VM. Computing device 102 can compare the initial completion prediction (e.g., based on the past 100 performances of creating a VM) with the actual completion prediction time (e.g., of the 101^{st} performance of creating the VM) to determine a prediction error based on the past 100 performances of task 104 relative to the latest performance of task 104.

Similar to the Gaussian data model, computing device 102 can determine the prediction error of the clustering data model by generating an initial completion prediction for task 104 using the clustering data model. The initial completion prediction can be based on historical task data about task 104. For example, task 104 may have been performed 100 times in the past, and based on the historical task data about the past 100 performances of task 104, computing device 102 can generate the initial completion prediction for the current instance (e.g., the 101^{st} performance) of task 104,

Computing device 102 can compare the initial completion prediction using the clustering data model to an actual task completion time of the task. For example, task 104 can be creating a VM. Computing device 102 can compare the initial completion prediction (e.g., based on the past 100 performances of creating a VM) with the actual completion prediction time (e.g., of the 101^{st} performance of creating the VM) to determine a prediction error based on the past 100 performances of task 104 relative to the latest performance of task 104.

As described above, computing device 102 can genera &update the Gaussian data model and the clustering data model for task 104 whenever task 104 is completed, and determine a prediction error for both data models. Computing device 102 can select the data model appropriately when presenting a completion prediction, as is described herein.

For example, computing device 102 can determine the prediction error for the Gaussian data model for task 104 to be 0.19% and determine the prediction error for the clustering data model for task 104 to be 0.28%. Accordingly, in response to a request for a completion prediction, computing device 102 can generate the completion prediction using the Gaussian data model based on the prediction error for the Gaussian data model (e.g., 0.19%) being less than the prediction error for the clustering data model (e.g., 0.28%).

Similarly, computing device 102 can determine the prediction error for the Gaussian data model for task 104 to be 0.28% and determine the prediction error for the clustering data model for task 104 to be 0.19%. Accordingly, in response to a request for a completion prediction, computing device 102 can generate the completion prediction using the clustering data model based on the prediction error for the clustering data model (e.g., 0.28%) being less than the prediction error for the Gaussian data model (e.g., 0.19%).

Computing device 102 can refrain from storing certain task data. For example, computing device 102 can determine a completion prediction for task 104, but can refrain from storing a task start time, a task end time, etc. Rather, computing device 102 can save, as part of the data models, prediction of task completions, as well as data model specific information. For example, computing device 102 can store values of a, b, m, and s with respect to the Gaussian data model, and can store cluster size information with respect to the clustering data model. In other words, computing device 102 can store the analysis outcomes of the received task data without storing all of the received task data. Storing this information while refraining from storing other information can prevent large amounts of data from having to be stored while still providing for accurate completion prediction for tasks.

As the Gaussian data model and the clustering data model for task 104 are continuously updated, underlying changes may be detected and accounted for utilizing generating a completion prediction of a task consistent with the disclosure. For example, task 104 may be applying a switch configuration to a network switch enclosure. Over many instances of task 104 being performed, the Gaussian data model may be generated/updated (e.g., the values of a, b, m, and s may change) and clustering information may change. As may occur in computing environments, a particular switch in the switch enclosure may be replaced, firmware may be updated, formatting of the switches may be changed, etc. Accordingly, task data of task 104 may be altered. As a result, the Gaussian data model and the clustering data model may be updated to reflect these changes.

Additionally, a same task 104 may have different task data based on where it is performed. Continuing with the example from above, applying a switch configuration to a switch enclosure may take different completion times based on the switch configuration being applied to different switch enclosures (e.g., switches in the enclosures may be different brands, models, have different firmware, have different formatting, etc.) Accordingly, completion times of task 104 may differ based on hardware configurations. While the different variables may alter task data for a same task 104, generating a completion prediction of a task, according to the disclosure, can automatically account for the differing variables between hardware, as well as changes in task data over time for a same task 104 on a particular system setup.

Generating a completion prediction of a task, according to the disclosure, can allow for accurate predictions for different types of tasks. Utilizing certain task data provided by external systems, a computing device can predict running times of such tasks (among other types of information). Further, changes to underlying systems performing tasks can be dynamically accounted for without readjusting task progression analysis code.

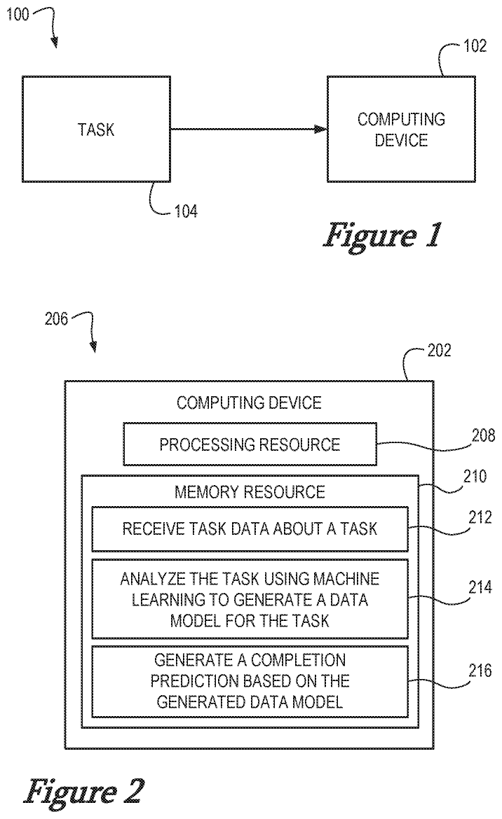

FIG. 2 is a block diagram 206 of an example computing device 202 for generating a completion prediction of a task consistent with the disclosure. As described herein, the computing device 202 may perform a number of functions related to generating a completion prediction of a task. Although not illustrated in FIG. 2, the computing device 202 may include a processor and a machine-readable storage medium. Although the following descriptions refer to a single processor and a single machine-readable storage medium, the descriptions may also apply to a system with multiple processors and multiple machine-readable storage mediums. In such examples, the computing device 202 may be distributed across multiple machine-readable storage mediums and the computing device 202 may be distributed across multiple processors. Put another way, the instructions executed by the computing device 202 may be stored across multiple machine-readable storage mediums and executed across multiple processors, such as in a distributed or virtual computing environment.

As illustrated in FIG. 2, the computing device 202 may comprise a processing resource 208, and a memory resource 210 storing machine-readable instructions to cause the processing resource 208 to perform a number of operations related to generating a completion prediction of a task. That is, using the processing resource 208 and the memory resource 210, the computing device 202 may generate a completion prediction of a task, among other operations. Processing resource 208 may be a central processing unit (CPU), microprocessor, and/or other hardware device suitable for retrieval and execution of instructions stored in memory resource 210.

The computing device 202 may include instructions 212 stored in the memory resource 210 and executable by the processing resource 208 to receive task data about a task. Task data can include, for example, a task start time and/or a task end time, task name, data about an underlying algorithm for performing the task, data about an underlying system performing the task, historical task data, among other examples of task data. Task data can be received by computing device 202 from an external system.

The computing device 202 may include instructions 214 stored in the memory resource 210 and executable by the processing resource 208 to analyze the task data using machine learning to generate a data model for the task. For example, computing device 202 can generate a Gaussian data model and a clustering data model utilizing the task data about the task.

The computing device 202 may include instructions 216 stored in the memory resource 210 and executable by the processing resource 208 to generate a completion prediction based on the generated data models for the task. For example, in response to a user input for a completion prediction, computing device 202 can generate a completion prediction utilizing the generated data models. For instance, computing device 202 can determine a prediction error for the Gaussian data model, a prediction error for the clustering data model, and generate the completion prediction utilizing the data model having the lower prediction error.

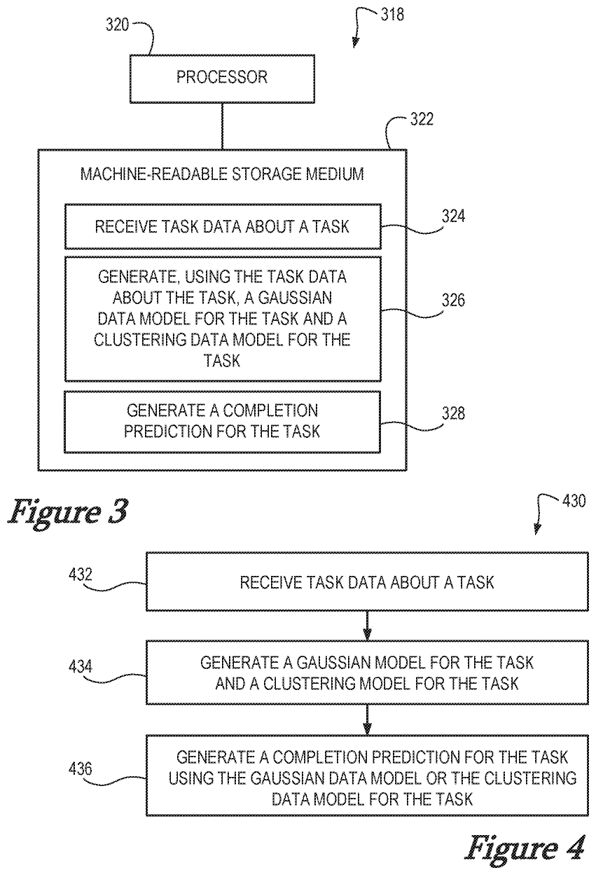

FIG. 3 is a block diagram of an example system 318 consistent with the disclosure. In the example of FIG. 3, system 318 includes a processor 320 and a machine-readable storage medium 322. Although the following descriptions refer to a single processor and a single machine-readable storage medium, the descriptions may also apply to a system with multiple processors and multiple machine-readable storage mediums. In such examples, non-transitory instructions may be distributed across multiple machine-readable storage mediums and the non-transitory instructions may be distributed across multiple processors. Put another way, the non-transitory instructions may be stored across multiple machine-readable storage mediums and executed across multiple processors, such as in a distributed computing environment.

Processor 320 may be a central processing unit (CPU), microprocessor, and/or other hardware device suitable for retrieval and execution of non-transitory instructions stored in machine-readable storage medium 322. In the particular example shown in FIG. 3, processor 320 may receive, determine, and send instructions 324, 326, and 328. As an alternative or in addition to retrieving and executing non-transitory instructions, processor 320 may include an electronic circuit comprising a number of electronic components for performing the operations of the instructions in machine-readable storage medium 322. With respect to the non-transitory executable instruction representations or boxes described and shown herein, it should be understood that part or all of the non-transitory executable instructions and/or electronic circuits included within one box may be included in a different box shown in the figures or in a different box not shown.

Machine-readable storage medium 322 may be any electronic, magnetic, optical, or other physical storage device that stores executable instructions. Thus, machine-readable storage medium 322 may be, for example, Random Access Memory (RAM), an Electrically-Erasable Programmable Read-Only Memory (EEPROM), a storage drive, an optical disc, and the like. The executable instructions may be “installed” on the system 318 illustrated in FIG. 3. Machine-readable storage medium 322 may be a portable, external or remote storage medium, for example, that allows the system 318 to download the instructions from the portable/external/remote storage medium. In this situation, the executable instructions may be part of an “installation package”. As described herein, machine-readable storage medium 322 may be encoded with executable instructions for generating a completion prediction of a task.

Receive instructions 324, when executed by a processor such as processor 320, may cause system 318 to receive task data about a task. Task data can include, for example, a task start time and/or a task end time, task name, data about an underlying algorithm for performing the task, data about an underlying system performing the task, historical task data, among other examples of task data.

Generate instructions 326, when executed by a processor such as processor 320, may cause system 318 to generate using the task data about the task a Gaussian data model for the task and a clustering data model for the task. System 318 can generate the Gaussian data model and the clustering data model for the task simultaneously. Further, system 318 can update the Gaussian data model and the clustering data model simultaneously as task data is received for the task.

Generate instructions 328, when executed by a processor such as processor 320, may cause system 318 to generate a completion prediction for the task using the Gaussian data model for the task or the clustering data model for the task. For example, system 318 may generate the completion prediction for the task in response to a user input. System 318 can utilize either the Gaussian data model or the clustering data model to generate the completion prediction based on a prediction error of the Gaussian data model and a prediction error of the clustering data model. For example, system 318 can generate the completion prediction for the task using either the Gaussian data model or the clustering data model based on whether the prediction error for one of the data models is less than the prediction error of the other of the data models.

FIG. 4 illustrates an example method 430 consistent with the disclosure. Method 430 may be performed, for example, by a computing device (e.g., computing device 102, 202, previously described in connection with FIGS. 1 and 2, respectively).

At 432, the method 430 may include receiving, by a computing device, task data about a task. Task data can include, for example, a task start time and/or a task end time, task name, data about an underlying algorithm for performing the task, data about an underlying system performing the task, historical task data, among other examples of task data.

At 434, the method 430 may include generating, by the computing device, a Gaussian data model for the task and a clustering data model for the task. The computing device can generate the Gaussian data model for the task and the clustering data model for the task using the task data about the task.

At 436, the method 430 may include generating, by the computing device, a completion prediction for the task using the Gaussian data model or the clustering data model for the task. The computing device can generate the completion prediction based on the prediction error of the Gaussian data model and a prediction error of the clustering data model. For example, the computing device can generate the completion prediction for the task using either the Gaussian data model or the clustering data model based on whether the prediction error for one of the data models is less than the prediction error of the other of the data models.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the disclosure.

The figures herein follow a numbering convention in which the first digit corresponds to the drawing figure number and the remaining digits identify an element or component in the drawing. Similar elements or components between different figures may be identified by the use of similar digits. For example, 102 may reference element “02” in FIG. 1, and a similar element may be referenced as 202 in FIG. 2. Elements shown in the various figures herein can be added, exchanged, and/or eliminated so as to provide a plurality of additional examples of the disclosure. In addition, the proportion and the relative scale of the elements provided in the figures are intended to illustrate the examples of the disclosure, and should not be taken in a limiting sense. As used herein, “a plurality of” an element and/or feature can refer to more than one of such elements and/or features.

What is claimed:

1. A computing device, comprising:
a processing resource; and
a memory resource storing non-transitory machine-readable instructions to cause the processing resource to:
receive task data about a task;
analyze the task data using machine learning to generate a data model for the task; and
generate a completion prediction based on the generated data model for the task.

2. The computing device of claim 1, wherein the data model is a Gaussian data model.

3. The computing device of claim 1, wherein the data model is a clustering data model.

4. The computing device of claim 1, wherein the completion prediction is a time to completion of the task.

5. The computing device of claim 1, wherein the completion prediction is a percentage complete indication.

6. The computing device of claim 1, including instructions to cause the processing resource to determine, based on a task name included in the task data, whether the task has been performed before.

7. The computing device of claim 6, including instructions to cause the processing resource to:
record, in response to the task not having been performed before, a task start time and task end time; and
determine a task completion time:

8. The computing device of claim 6, including instructions to cause the processing resource to:
generate, in response to the task having been performed before, an initial completion prediction based on historical task data about the task; and
update, based on an actual task completion time of the task, the data model for the task.

9. The computing device of claim 1, wherein the task data includes at least one of:
a task start time of the task; and
a task end time of the task.

10. A non-transitory computer readable medium storing instructions executable by a processing resource to cause the processing resource to:
receive task data about a task;
generate, using the task data about the task:
a Gaussian data model for the task; and
a clustering data model for the task; and
generate a completion prediction for the task using the Gaussian data model for the task or the clustering data model for the task.

11. The medium of claim 10, comprising instructions to generate a completion prediction using the Gaussian data model or the clustering data model based on a prediction error of the Gaussian data model and a prediction error of the clustering data model.

12. The medium of claim 11, comprising instructions to determine the prediction error of the Gaussian data model by:
generating an initial completion prediction using the Gaussian data model based on historical task data about the task; and
comparing the initial completion prediction using the Gaussian data model prediction to an actual task completion time of the task.

13. The medium of claim 11, comprising instructions to determine the prediction error of the clustering data model by:
generating an initial completion prediction using the clustering data model based on historical task data about the task; and
comparing the initial completion prediction using the clustering data model to an actual task completion time of the task.

14. The medium of claim 11 wherein the instructions to generate the completion prediction for the task include instructions to generate the completion prediction using the Gaussian data model based on the prediction error of the Gaussian data model being less than the prediction error of the clustering data model.

15. The medium of claim 11, wherein the instructions to generate the completion prediction for the task include instructions to generate the completion prediction using the clustering data model based on the prediction error of the clustering data model being less than the prediction error of the Gaussian data model.

16. A method, comprising:
receiving, by a computing device, task data about a task;
generating, by the computing device using the task data about the task:
a Gaussian data model for the task; and
a clustering data model for the task; and
generating, by the computing device, a completion prediction for the task using the Gaussian data model for the task or the clustering data model for the task based on a prediction error of the Gaussian data model and a prediction error of the clustering data model.

17. The method of claim 16, wherein generating the Gaussian data model for the task includes:
comparing an initial completion prediction based on historical task data about the task with an actual task completion time of the task;
determining a prediction error; and
minimizing the prediction error.

18. The method of claim 16, wherein generating the clustering data model for the task includes:
determining a cluster size for the task; and
classifying the task into the cluster size for the task.

19. The method of claim 16, wherein the method includes:
periodically calling, by the computing device, to an external system at a predetermined interval for the task data about the task; and
receiving, by the computing device, the task data in response to the periodic call.

20. The method of claim 16, wherein the method includes calling, by the computing device, to an external system for historical task data about the task.
